(19) United States
(12) Patent Application Publication
(10) Pub. No.: US 2014/0078724 A1
(43) Pub. Date: Mar. 20, 2014

(54) PORTABLE LIGHTING APPARATUS

(71) Applicant: EDISON NATION, LLC, Charlotte, NC (US)

(72) Inventor: Barbara G. BENDIT, Phoenix, AZ (US)

(21) Appl. No.: 13/801,806

(22) Filed: Mar. 13, 2013

Related U.S. Application Data
(60) Provisional application No. 61/701,383, filed on Sep. 14, 2012.

(51) Int. Cl. F21V 21/40; F21V 21/30; F21V 3/00; F21V 3/04; F21L 4/02; F21V 19/00

(52) U.S. Cl. CPC F21V 21/406; F21L 4/02; F21V 19/00; F21V 3/00; F21V 3/049; F21V 21/30
USPC 362/184; 362/249.01; 362/237; 362/249.07

(57) ABSTRACT

A portable lighting apparatus includes a plurality of connected lighting components and a handle attached to at least one of the plurality of lighting components. Each lighting component includes at least one bulb. The lighting components are arrangeable relative to one another into a plurality of configurations, including at least a collapsed configuration and an upright configuration.

### CROSS REFERENCE TO RELATED APPLICATIONS

The present application is a U.S. non-provisional patent application of, and claims priority under 35 U.S.C. §119(e) to, U.S. provisional patent application Ser. no. 61/701,383, filed Sep. 14, 2012, which is expressly incorporated by reference herein in its entirety.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND

1. Field

The present invention relates generally to portable lighting devices.

2. Background

Extra lighting can be useful in a variety of different environments, such as in a home or at a workplace. However, in many cases, lighting is not always available where it is needed most. Furthermore, flashlights and other known portable lighting devices often require the user to hold the lighting device with one hand, thereby limiting the user's ability to perform tasks. Other portable lighting devices must be plugged directly into a power source or outlet, which can limit the device's useful range.

Accordingly, a need exists for a portable lighting device that has broad utility in a range of different environments. This, and other needs, is addressed by the present invention.

### SUMMARY

Broadly defined, the present invention according to a first aspect includes a portable lighting apparatus. The portable lighting apparatus includes a plurality of lighting components and a handle attached to at least one of the lighting components. The lighting components are arrangeable relative to one another into a plurality of configurations. Each lighting component includes at least one bulb.

In features of this aspect, each of the plurality of lighting components may be powered by one or more batteries; the at least one bulb of each of the plurality of lighting components may be a LED lightbulb; the plurality of lighting components may be arrangeable between a collapsed configuration and an upright configuration; and/or at least one of the lighting components may include an attachment device at a rear side thereof.

In further features of this aspect, each lighting component may include a bulb cover for the at least one bulb; the bulb cover may be frosted; and/or the bulb cover may be made from a plastic material.

In still further features of this aspect, the handle may attach to two of the plurality of lighting components; and/or the handle may be collapsible.

Broadly defined, the present invention according to a second aspect includes a portable lighting apparatus substantially as shown and described.

Broadly defined, the present invention according to a third aspect includes a portable lighting kit. The portable lighting kit includes a portable lighting apparatus comprised of a plurality of lighting components and a storage case for housing the portable lighting apparatus. The lighting components are arrangeable relative to one another into a plurality of configurations. Each lighting component includes at least one bulb.

In features of this aspect, each of the plurality of lighting components may be powered by one or more batteries; the at least one bulb of each of the plurality of lighting components may be a LED lightbulb; the plurality of lighting components may be arrangeable between a collapsed configuration and an upright configuration; and/or the portable lighting apparatus may include at least one attachment device at a rear side thereof to permit attachment to a surface.

In further features of this aspect, each lighting component may include a bulb cover for the at least one bulb; the bulb cover may be frosted; and/or the bulb cover may be made from a plastic material.

In still further features of this aspect, the portable lighting apparatus may include a handle attached to at least one of the lighting components; the handle may attach to two of the plurality of lighting components; and/or the handle may be collapsible.

Broadly defined, the present invention according to a fourth aspect includes a portable lighting kit substantially as shown and described.

Broadly defined, the present invention according to a fifth aspect includes a method of using a portable lighting apparatus substantially as shown and described.

Broadly defined, the present invention according to a sixth aspect includes a portable lighting apparatus that includes a plurality of connected lighting components and a handle attached to at least one of the plurality of lighting components. Each lighting component includes at least one bulb. The lighting components are arrangeable relative to one another into a plurality of configurations, including at least a collapsed configuration and an upright configuration.

In features of this aspect, each of the plurality of lighting components may be powered by one or more batteries; and/or the at least one bulb of each of the plurality of lighting components may be a LED bulb.

In further feature of this aspect, at least one of the plurality of lighting components may include an attachment device at a rear side thereof; and/or the attachment device may be a suction cup.

In still further features of this aspect, at least one of the plurality of lighting components may include a bulb cover for the at least one bulb; the bulb cover may be frosted; the bulb cover may be made from a plastic material; and/or the bulb cover may be manually actuatable to cover the at least one bulb.

In still further features of this aspect, the handle may attach to at least two of the plurality of lighting components; the handle may be collapsible; at least one of the plurality of lighting components may include at least five bulbs; adjoining lighting components may be attached together with a hinge; and/or each of the plurality of lighting components may be powered independently of the other lighting components.

Broadly defined, the present invention according to a seventh aspect includes a portable lighting apparatus that includes a plurality of connected lighting components, a handle attached to at least one of the plurality of lighting components, and a plurality of frosted bulb covers. Each lighting component includes at least one bulb. Each of the plurality of frosted bulb covers is adapted to cover the at least one bulb of a respective one of the plurality of lighting components. The lighting components are arrangeable relative to one another into a plurality of configurations, including at least a collapsed configuration and an upright configuration.

In a feature of this aspect, the at least one bulb of each of the plurality of lighting components may be a LED bulb.

In further features of this aspect, at least one of the plurality of lighting components may include an attachment device at a rear side thereof; and/or the attachment device may be a suction cup.

In still further features of this aspect, each of the plurality of bulb covers may be manually actuatable to cover the at least one bulb; and/or each of the plurality of lighting components may be powered independently of the other lighting components.

Broadly defined, the present invention according to an eighth aspect includes a portable lighting kit that includes a portable lighting apparatus comprised of a plurality of connected lighting components. Each lighting component includes at least one bulb. The lighting components are arrangeable relative to one another into a plurality of configurations, including at least a collapsed configuration and an upright configuration. The portable lighting kit further includes a storage case for housing the portable lighting apparatus when in the collapsed configuration.

In features of this aspect, each of the plurality of lighting components may be powered by one or more batteries; and/or the at least one bulb of each of the plurality of lighting components may be a LED bulb.

In further features of this aspect, at least one of the plurality of lighting components may include an attachment device at a rear side thereof; and/or the attachment device may be a suction cup.

In still further features of this aspect, at least one of the plurality of lighting components may include a bulb cover for the at least one bulb; the bulb cover may be frosted; the bulb cover may be made from a plastic material; and/or the bulb cover may be manually actuatable to cover the at least one bulb.

In still further features of this aspect, the portable lighting apparatus may include a handle attached to at least one of the plurality of lighting components; the handle may attach to at least two of the plurality of lighting components; and/or the handle may be collapsible.

In still further features of this aspect, at least one of the plurality of lighting components may include at least five bulbs; adjoining lighting components may be attached together with a hinge; and/or each of the plurality of lighting components may be powered independently of the other lighting components.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Further features, embodiments, and advantages of the present invention will become apparent from the following detailed description with reference to the drawings, wherein:

FIG. 1 is a perspective view of a portable lighting apparatus, shown in a collapsed configuration, in accordance with one or more embodiments of the present invention;

FIG. 2 is a perspective view of the portable lighting apparatus of FIG. 1, shown in an upright configuration;

FIG. 3 a rear perspective view of the portable lighting apparatus of FIG. 1, shown in the collapsed configuration;

FIG. 4 is an enlarged fragmentary view of the portable lighting apparatus of FIG. 3;

FIG. 5 is an enlarged fragmentary view of the portable lighting apparatus of FIG. 3, shown with a rear cover of one of the lighting components in an open position;

FIG. 6 is a perspective view of the portable lighting apparatus of FIG. 1, together with a storage case;

FIG. 7 is an enlarged fragmentary view of the portable lighting apparatus of FIG. 1, shown with a bulb cover partially removed; and

FIGS. 8 and 9 are schematic views of a lighting component of a portable lighting apparatus in accordance with one or more embodiments of the present invention.

### DETAILED DESCRIPTION

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers,” “a picnic basket having crackers without cheese,” and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, in which like numerals represent like components throughout the several views, the preferred embodiments of the present invention are next described. The following description of one or more preferred embodiment(s) is merely exemplary in nature and is in no way intended to limit the invention, its application, or uses.

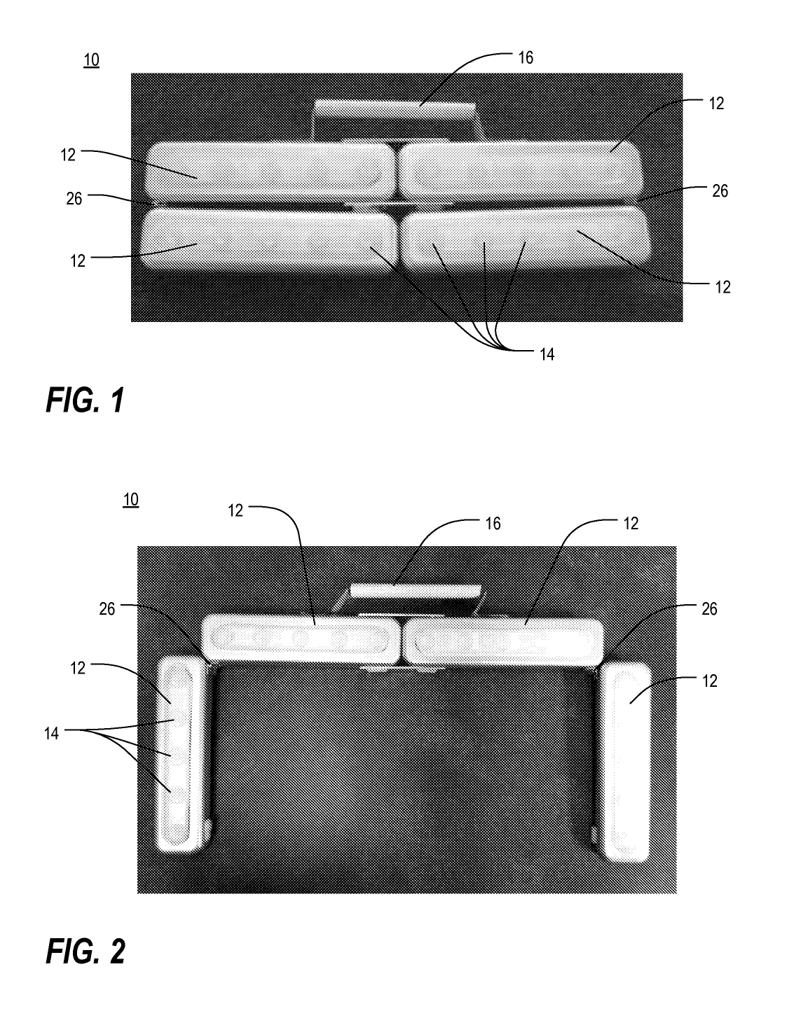

FIG. 1 is a perspective view of a portable lighting apparatus 10, shown in a collapsed configuration, in accordance with one or more embodiments of the present invention. The portable lighting apparatus 10 includes four lighting components 12 attached together. Though four lighting components 12 are depicted, it is contemplated that the portable lighting component 10 may include more or less lighting components 12.

At least some of the lighting components 12 are attached together at their respective ends by hinges 26 that permit the lighting components 12 to be pivotably arranged relative to one another. As shown in FIG. 1, the lighting components 12 are arranged fully against one another such that the lighting apparatus 10 is in a collapsed configuration. In the collapsed configuration, it is contemplated that the lighting apparatus 10 can be stored for travel purposes or can be used as a handheld lighting device.

As further shown in FIG. 1, a handle 16 is attached to the lighting apparatus 10, which permits a user to carry or transport the lighting apparatus 10 with relative ease. The handle 16 is collapsible against the lighting apparatus 10 for storage or when set up for use.

Each lighting component 12 includes at least one bulb 14. In the embodiment shown in FIG. 1, each lighting component 12 includes five bulbs, although it is contemplated that each lighting component 12 may have more or less bulbs 14. In a contemplated embodiment, each bulb is a LED lightbulb. Furthermore, it is contemplated that the lighting components 12 are each LED Mini Tasklite™ devices, which are manufactured and sold by Amer-Tac, Inc. of Saddle River, N.J.

FIG. 2 is a perspective view of the portable lighting apparatus 10 of FIG. 1, shown in an upright configuration. The lighting apparatus 10 is configurable to other configurations. In the upright configuration, depicted in FIG. 2, two of the lighting components 12 are pivoted so as to provide the lighting apparatus 10 with upright supports. In the upright configuration, the lighting apparatus 10 is capable of being supported in an upright position on the upright supports, and it is contemplated that the lighting apparatus can be used to light a vanity counter or a mirror. Furthermore, in the upright configuration, it is contemplated that the lighting apparatus 10 can be used as under-cabinet task lighting, as a nightlight, or as an all-purpose freestanding light. As shown in FIG. 2, the two pivoted lighting components are arranged to form generally right angles relative to the stationary lighting components. However, it is contemplated that the portable lighting apparatus is capable of arrangement in a wide variety of different configurations, with one or more of the lighting components being arranged at any of a wide range of different angles relative to other lighting components.

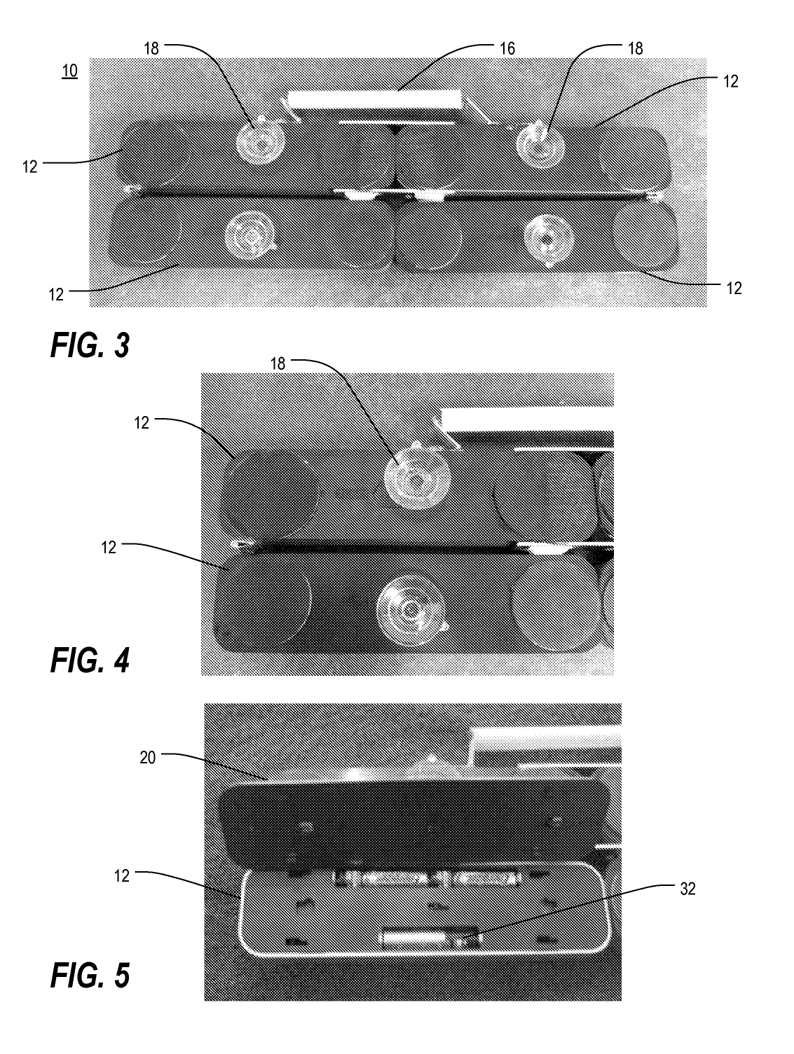

FIG. 3 a rear perspective view of the portable lighting apparatus 10 of FIG. 1, shown in the collapsed configuration. FIG. 4 is an enlarged fragmentary view of the portable lighting apparatus 10 of FIG. 3. As shown in FIGS. 3 and 4, the rear sides of the lighting components 12 are fitted with attachment devices 18 that allow the lighting apparatus 10 to be attached to or against a surface. In a contemplated embodiment, the attachment devices 18 are suction cups, which permit the lighting apparatus 10 to be attached to a surface such as a mirror or a pane of glass.

FIG. 5 is an enlarged fragmentary view of the portable lighting apparatus 10 of FIG. 3, shown with a rear cover 20 of one of the lighting components 12 in an open position. Each lighting component includes a rear cover 20 that is removable or pivotable to permit a user to replenish the power source 32 for the lighting apparatus 10. In a contemplated embodiment, each lighting component 12 is battery-operated.

It is further contemplated that each lighting component 12 can be powered on and off separately from the other lighting components 12. In this manner, a user is able to select the amount of light necessary to meet the lighting requirements under a given set of circumstances. For instance, when used to light a vanity counter or a mirror, it might be desirable to power the full allotment of lighting components 12 in order to provide the maximum amount of light. For other purposes, however, there may be a need to power less than the full allotment of lighting components 12, such as when the lighting apparatus 10 is used as a nightlight. Still further, there may exist a need to have light targeted toward a specific area, such as during use as a flashlight, in which case there may be a need to power only a specifically selected lighting component 12 of the lighting apparatus 10. Each lighting component 12 is powered on and off by actuation of a switch. In a contemplated embodiment, each lighting component 12 is powered on and off by a user's touch.

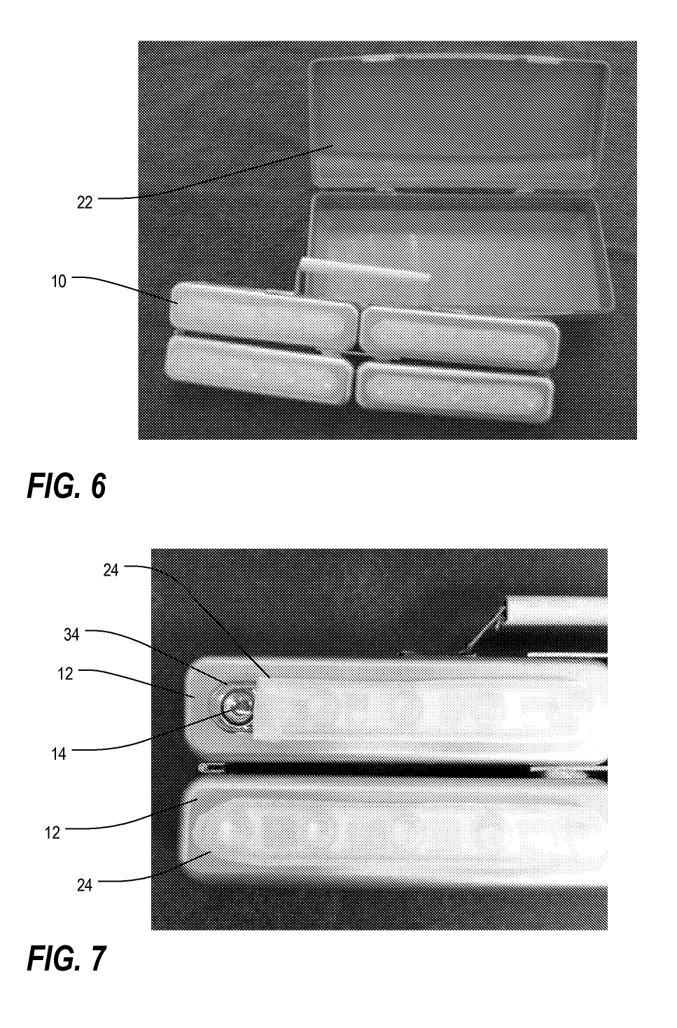

FIG. 6 is a perspective view of the portable lighting apparatus 10 of FIG. 1, together with a storage case 22. The lighting apparatus 10 can be packaged or provided with a storage case 22. The storage case 22 is sized and shaped to comfortably accommodate the lighting apparatus 10 when in the collapsed configuration. In a contemplated embodiment, the storage case 22 includes a lid with fasteners to keep the lid closed.

FIG. 7 is an enlarged fragmentary view of the portable lighting apparatus 10 of FIG. 1, shown with a bulb cover 24 partially removed. Each lighting component 12 further includes a frosted bulb cover 24 that extends to cover the one or more bulbs 14 of each lighting component 12. In a contemplated embodiment, the bulb cover 24 is made of a plastic material. The frosted surface of the bulb cover 24 cuts down on glare associated with the one or more bulbs 14, which can be useful when the lighting apparatus 10 is used in connection with a mirror.

Optionally, the bulb cover 24 is removable to reveal a clear cover 34 underneath. In this manner, light emitted from the lighting apparatus 10 is muted when the frosted bulb cover 24 extends to cover the one or more bulbs 14. When the frosted bulb cover 24 is removed, light emitted from the lighting apparatus 10 is bright and unfiltered, which can be useful when the lighting apparatus 10 is used as task lighting or as a flashlight.

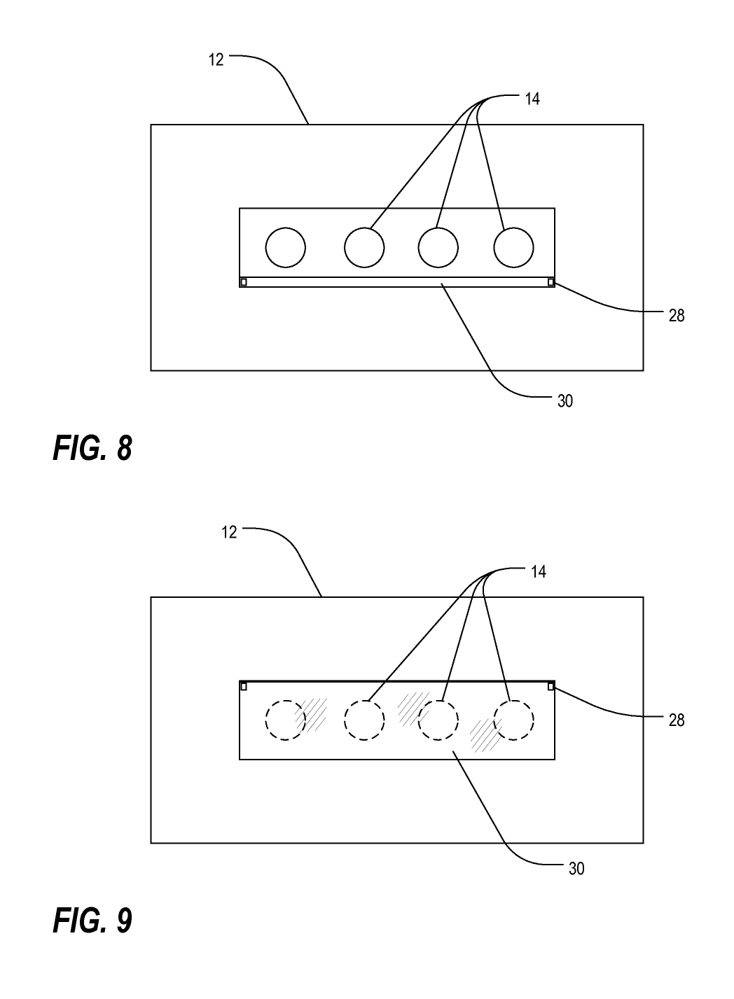

FIGS. 8 and 9 are schematic views of a lighting component 12 of a portable lighting apparatus 10 in accordance with one or more embodiments of the present invention. As shown in FIGS. 8 and 9, a frosted shield 30 can be extended to cover the one or more bulbs 14 of each lighting component 12 (in place of a frosted bulb cover 24, discussed in connection with FIG. 7). By actuating a manual switch 28, the frosted shield 30 can be positioned to fully cover the one or more bulbs 14, thereby muting the light emitted by the lighting apparatus 10. When bright, unfiltered light is needed, the frosted shield 30 can be positioned, using the switch 28, to be hidden within the lighting component 12. Furthermore, if a need exists for partially muted light (i.e., some filtered light in combination with some unfiltered light), it is contemplated that the frosted shield 30 can be positioned to partially cover the one or more bulbs 14, thereby filtering only a portion of the light emitted by the lighting component 12.

The lighting apparatus 10 can be manufactured from lightweight, portable materials, thereby increasing the suitability of the lighting apparatus 10 for travel.

Based on the foregoing information, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention.

Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements; the present invention being limited only by the claims appended hereto and the equivalents thereof.

1. A portable lighting apparatus comprising:
a plurality of connected lighting components, each lighting component including at least one bulb; and
a handle attached to at least one of the plurality of lighting components;
wherein the lighting components are arrangeable relative to one another into a plurality of configurations, including at least a collapsed configuration and an upright configuration.

2. The portable lighting apparatus of claim 1, wherein each of the plurality of lighting components is powered by one or more batteries.

3. The portable lighting apparatus of claim 1, wherein the at least one bulb of each of the plurality of lighting components is a LED bulb.

4. The portable lighting apparatus of claim 1, wherein at least one of the plurality of lighting components includes an attachment device at a rear side thereof.

5. The portable lighting apparatus of claim 4, wherein the attachment device is a suction cup.

6. The portable lighting apparatus of claim 1, wherein at least one of the plurality of lighting components includes a bulb cover for the at least one bulb.

7. The portable lighting apparatus of claim 6, wherein the bulb cover is frosted.

8. The portable lighting apparatus of claim 6, wherein the bulb cover is made from a plastic material.

9. The portable lighting apparatus of claim 6, wherein the bulb cover is manually actuatable to cover the at least one bulb.

10. The portable lighting apparatus of claim 1, wherein the handle attaches to at least two of the plurality of lighting components.

11. The portable lighting apparatus of claim 1, wherein the handle is collapsible.

12. The portable lighting apparatus of claim 1, wherein at least one of the plurality of lighting components includes at least five bulbs.

13. The portable lighting apparatus of claim 1, wherein adjoining lighting components are attached together with a hinge.

14. The portable lighting apparatus of claim 1, wherein each of the plurality of lighting components is powered independently of the other lighting components.

15. A portable lighting apparatus comprising:
a plurality of connected lighting components, each lighting component including at least one bulb;
a handle attached to at least one of the plurality of lighting components; and
a plurality of frosted bulb covers, each adapted to cover the at least one bulb of a respective one of the plurality of lighting components;
wherein the lighting components are arrangeable relative to one another into a plurality of configurations, including at least a collapsed configuration and an upright configuration.

16. The portable lighting apparatus of claim 15, wherein the at least one bulb of each of the plurality of lighting components is a LED bulb.

17. The portable lighting apparatus of claim 15, wherein at least one of the plurality of lighting components includes an attachment device at a rear side thereof.

18. The portable lighting apparatus of claim 17, wherein the attachment device is a suction cup.

19. The portable lighting apparatus of claim 15, wherein each of the plurality of bulb covers is manually actuatable to cover the at least one bulb.

20. The portable lighting apparatus of claim 15, wherein each of the plurality of lighting components is powered independently of the other lighting components.

21.-35. (canceled)
